(19) United States
(12) Patent Application Publication
(10) Pub. No.: US 2001/0024907 A1
(43) Pub. Date: Sep. 27, 2001

(54) Waterproof dummy connector

(76) Inventors: Takao Murakami, Shizuoka (JP); Mitsuharu Nakamura, Shizuoka (JP)

Correspondence Address: SUGHRUE, MION, ZINN, MACPEAK & SEAS, PLLC, 2100 Pennsylvania Avenue, N.W., Washington, DC, 20037, US

(21) Appl. No.: 09/812,687

(22) Filed: Mar. 21, 2001

(30) Foreign Application Priority Data
Mar. 21, 2000 (JP) P. 2000-78005

(51) Int. Cl. H01R 13/44; H01R 13/40

(52) U.S. Cl. 439/587

(57) ABSTRACT

In a dummy connector, for sealing a fitting hole formed in a female connector, instead of a male connector, a main body inserted into the fitting hole, and a sealing portion fitted with an inner face of the fitting hole are integrally made of thermoplastic elastomer resin.

### BACKGROUND OF THE INVENTION

The present invention relates to a waterproof dummy connector fills a fitting hole for a male connector which is formed in a female connector, to provide a waterproof sealing instead of the male connector.

A cross sectional view of an example related waterproof dummy connector of this type is shown in FIG. 2. A waterproof dummy connector 1 is produced as a two-component assembly, wherein a packing 4, made of elastic rubber, is fitted around an outer periphery of a fitting convex 3 of a dummy connector main body 2, made of a hard resin.

Since the related waterproof dummy connector 1 is a two-part assembly, comprising the dummy connector main body 2, made of hard resin, and the packing 4, made of elastic rubber, and expenditures for assembly and parts are high, the unit manufacturing cost is excessive.

### SUMMARY OF THE INVENTION

To resolve this shortcoming, so as to reduce the manufacturing cost, it is one objective of the invention to provide a waterproof dummy connector for which unit assembly and part expenditures are decreased by reducing the required number of parts from two to one.

In order to achieve the above object, according to the invention, there is provided a dummy connector, for sealing a fitting hole formed in a female connector, instead of a male connector, comprising:

a main body inserted into the fitting hole; and

a sealing portion fitted with an inner face of the fitting hole,

wherein the main body and the sealing portion are integrally made of thermoplastic elastomer resin.

When the waterproof dummy connector is used, the main body is fitted into and fills the fitting hole in the female connector, and since at this time the integrally formed sealing portion closely engages the inner face of the fitting hole, the hole is sealed.

In this configuration, since the relative elasticity of thermoplastic elastomer resin lies midway between those of hard resin and of rubber, both the overall shape and the sealing strength can be maintained. Further, since thermoplastic elastomer resin is employed, the dummy connector main body and the sealing portion can be integrally formed, so that the parts number can be reduced to one.

Preferably, a closing wall is formed at a rear part of the main body for closing the fitting hole. The sealing portion is provided on an outer periphery of the closing wall. A lock arm which is engaged with an engagement member formed inside of the fitting hole is formed on the main body in a front side of the closing wall.

Since the locking arm projects outward from the front face of the closing wall of the dummy connector main body, when the waterproof dummy connector is fitted into the fitting hole it can be surely prevented from falling out.

Preferably, a pair of recessed portions are formed in a rear face of the closing wall, so as to define a gripping wall therebetween.

In this configuration, two fingers can be inserted into the recessed portions, one finger in each, and when pressure is applied to the gripping wall, the waterproof dummy connector can be easily removed from or inserted into a fitting hole. Further, even though the thin walls at the recessed portions reduce the strength at the sealing portion, since the walls are reinforced by a gripping wall that serves as a ribs, there is little actual reduction in the strength at the sealing portion, and a sealed state can be maintained for an extended period of time.

Preferably, a projection is formed on the lock arm for engaging with the engagement member formed in the fitting hole. The projection has a front slope face and a rear slope face which extend in an inserting direction of the dummy connector. The rear slope face is steeper than the front slope face.

In this configuration, because of the gentle slope of the front slope face, only a small amount of force is required to insert the waterproof dummy connector, while to remove the waterproof dummy connector, slightly more force is required because of the steeper rear slope face.

### BRIEF DESRIPTION OF THE DRAWINGS

In the accompanying drawings:

FIG. 1A is a rear perspective view of a waterproof connector according to one embodiment of the invention, wherein a waterproof dummy connector is to be fitted into a fitting hole formed in a female connector;

FIG. 1B is a front perspective view of the waterproof dummy connector;

FIG. 1C is a cross-sectional view taken along the line Ic-Ic in FIG. 1B; and

FIG. 2 is a cross-sectional view of a related waterproof dummy connector.

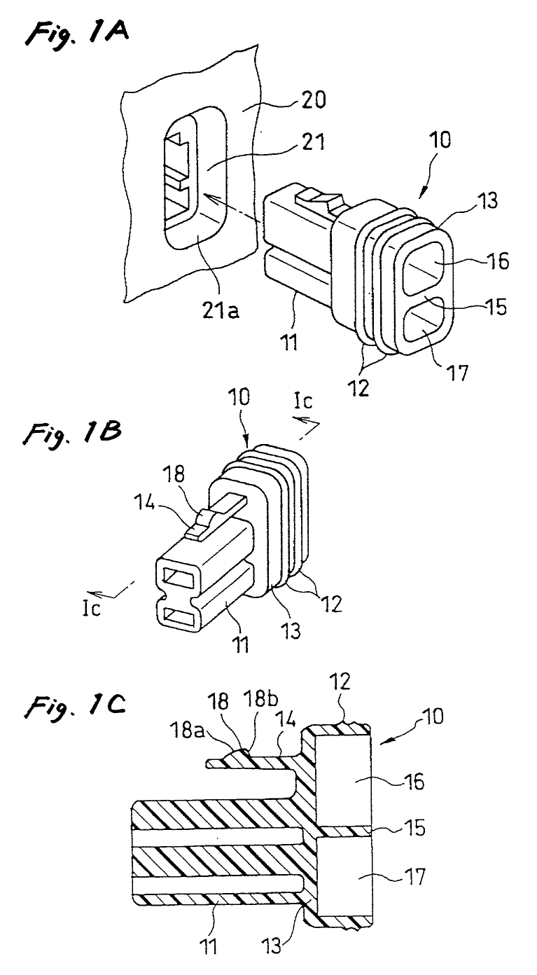

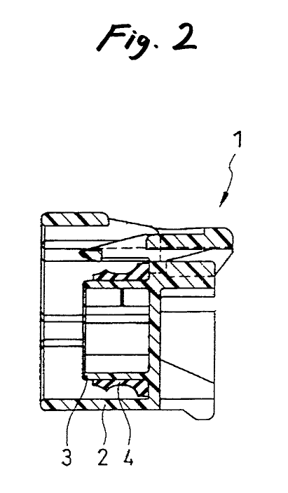

### DETAILED DESRIPTION OF THE PREFERRED EMBODIMENTS

The preferred embodiment of the invention will now be described while referring to the accompanying drawings.

A waterproof dummy connector 10 is used, instead of a male connector, to fill a male connector fitting hole 21 formed in a female connector 20. The waterproof dummy connector 10 comprises a main body 11, which is inserted into and fills the fitting hole 21; and sealing portions (sealing lips) 12, which closely fit with an inner face 21a of the fitting hole 21. The main body 11 and the sealing portion 12, which are integrally formed of thermoplastic elastomer resin, are large enough to tightly fit in the fitting hole 21.

At the rear of the dummy connector main body 11, the sealing portions 12 are provided around the outer face, and a closing wall 13 is formed to fill the mouth of the fitting hole 21. An integrally formed locking arm 14 projects outward from the front face of the closing wall 13, and engages with a protrusion (not shown) in the fitting hole 21.

A projection 18 for engaging the protrusion in the fitting hole 21 is formed on the locking arm 14. A front wall 18a of the projection 18 has a gentle slope, and while a rear wall 18b is not vertical, it has a rather steep slope. With this arrangement, because of the gentle slope of the front wall 18a, only a small amount of force is required to insert the waterproof dummy connector 10, while to remove the waterproof dummy connector 10, slightly more force is required because of the steeply sloped rear wall 18b. Further, two recessed portions 16 and 17 are formed in the rear face of the closing wall 13 with a horizontal gripping wall 15 in between.

When this waterproof dummy connector 10 is employed, the main body 11 is fitted into the fitting hole 21 of a female connector 20, and the mouth of the fitting hole 21 is filled by the closing wall 13. Then, since the integrally formed sealing portions 12 closely fit with the inner face 21a of the fitting hole 21, the fitting hole 21 is sealed. Further, since the locking arm 14 engages the protrusion formed in the fitting hole 21, the waterproof dummy connector 10 is securely held and will not fall out. In this state, the entire waterproof dummy connector 10 is accommodated inside the fitting hole 21, so that there are no protruding portions.

To remove the waterproof dummy connector 10 from the female connector 20, a modicum of force is required to pull it from the fitting hole 21.

For insertion and removal, since the two recessed portions 16 and 17 are formed in the rear face of the closing wall 13 with the gripping wall 15 in between, only two fingers, individually inserted into the recessed portions 16 and 17, are required to hold the gripping wall 15. Thus, the waterproof dummy connector 10, which in size is small enough to be completely accommodated in the fitting hole 21, can be easily inserted in or removed from the fitting hole 21.

The gripping wall 15 also functions as a rib, and serves to reinforce the strength of the sealing portions 12, which may be deteriorated by the thin walls at the recessed portions 16 and 17. Therefore, the gripping wall 15, by countering a reduction in the strength at the sealing portions 12, contributes to the maintenance of a secure sealed state for an extended period of time.

In addition, since the relative elasticity of thermoplastic elastomer resin, the material used for the waterproof dummy connector 10, lies midway between those of hard resin and rubber, the overall shape and the sealing strength of the waterproof dummy connector 10 can be maintained. Furthermore, since the dummy connector main body 11 and the sealing portion 12 are integrally formed of using thermoplastic elastomer, the parts number can be reduced to one, so that assembly and part expenditures can be decreased, and accordingly, the unit manufacturing cost can be reduced.

Although the present invention has been shown and described with reference to the specific preferred embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. A dummy connector, for sealing a fitting hole formed in a female connector, instead of a male connector, comprising:
a main body inserted into the fitting hole; and
a sealing portion fitted with an inner face of the fitting hole,
wherein the main body and the sealing portion are integrally made of thermoplastic elastomer resin.

2. The dummy connector as set forth in claim 1, wherein a closing wall is formed at a rear part of the main body for closing the fitting hole;
wherein the sealing portion is provided on an outer periphery of the closing wall; and
wherein a lock arm which is engaged with an engagement member formed inside of the fitting hole is formed on the main body in a front side of the closing wall.

3. The dummy connector as set forth in claim 2, wherein a pair of recessed portions are formed in a rear face of the closing wall, so as to define a gripping wall therebetween.

4. The dummy connector as set forth in claim 2, wherein a projection is formed on the lock arm for engaging with the engagement member formed in the fitting hole;
wherein the projection has a front slope face and a rear slope face which extend in an inserting direction of the dummy connector; and
wherein the rear slope face is steeper than the front slope face.
